(19) United States
(12) Patent Application Publication
(10) Pub. No.: US 2006/0226259 A1
(43) Pub. Date: Oct. 12, 2006

(54) Spray washer

(75) Inventor: Niels Kristian Lund, Hedensted (DK)

Correspondence Address: WOOD, HERRON & EVANS, LLP, 2700 CAREW TOWER, 441 VINE STREET, CINCINNATI, OH, 45202, US

(73) Assignee: JWL Maskin- & Plastfabrik, Hedensted (DK)

(21) Appl. No.: 11/101,781

(22) Filed: Apr. 8, 2005

(51) Int. Cl. B05B 7/04; F23D 11/10; E03C 1/08; A62C 31/00

(52) U.S. Cl. 239/398; 239/418; 239/428.5

(57) ABSTRACT

An apparatus for spray washing includes a handle member which includes an air inlet and a water inlet. Both inlets lead to separate valves that are actuated simultaneously by a lever mechanism. These lead to a venturi orifice that is in communication with a reservoir of detergent that further includes a valve to open and close the passage into the reservoir. Downstream of the spray apparatus is a water valve which can be used to shut off water flow to the apparatus. The apparatus can be used to spray only air, or a combination of air and water, or a combination of air, water and detergent.

### BACKGROUND OF THE INVENTION

The present invention relates to spray guns and, specifically, spray guns utilizing both a source of compressed air and water.

There are several types of spray systems used to wash cars, and the like. These systems spray water and/or detergent and/or compressed air, in various combinations. Some will use a combination of air, water and solvent or detergent such as is disclosed in Hunter, U.S. Pat. No. 2,322,296, and Johnson U.S. Pat. No. 2,893,645. These systems should be effective; however, they are relatively complicated to manufacture and/or use.

### SUMMARY OF THE INVENTION

The present invention is a spray washer which utilizes sources of water and air, and has a detergent reservoir wherein both the air and the water can be turned on with simply a squeeze of a handle or trigger. These, in turn, can be run through a venturi-type device to draw detergent into the combined stream of air and water, as desired. Further, the device includes a separate water valve to enable one to shut off the water and use only air. The device is simple to operate, with minimal moving parts. By turning off the detergent valve and turning off the attached water valve, one can simply spray air which will allow one to remove dust prior to washing and to dry a surface off subsequent to washing.

The objects and advantages of the present invention will be further appreciated in light of the detailed description and drawings in which:

### BRIEF DESCRIPTION OF THE DRAWINGS

FIG. 1 is a perspective view of the present invention;

FIG. 2 is a partially elevational cross section of the device along line 2/2 of FIG. 1;

FIG. 3 is a cross sectional view taken at lines 3/3 of FIG. 2 with the water actuation valve removed.

FIG. 4 is a cross sectional view taken at lines 4/4 of FIG. 3;

FIG. 5 is a cross section of nozzle/bottle portion of the device taken along 5/5/ of FIG. 2;

FIG. 6 is a cross sectional view of nozzle/bottle along 6/6 of FIG. 5.

### DETAILED DESCRIPTION OF THE DRAWINGS

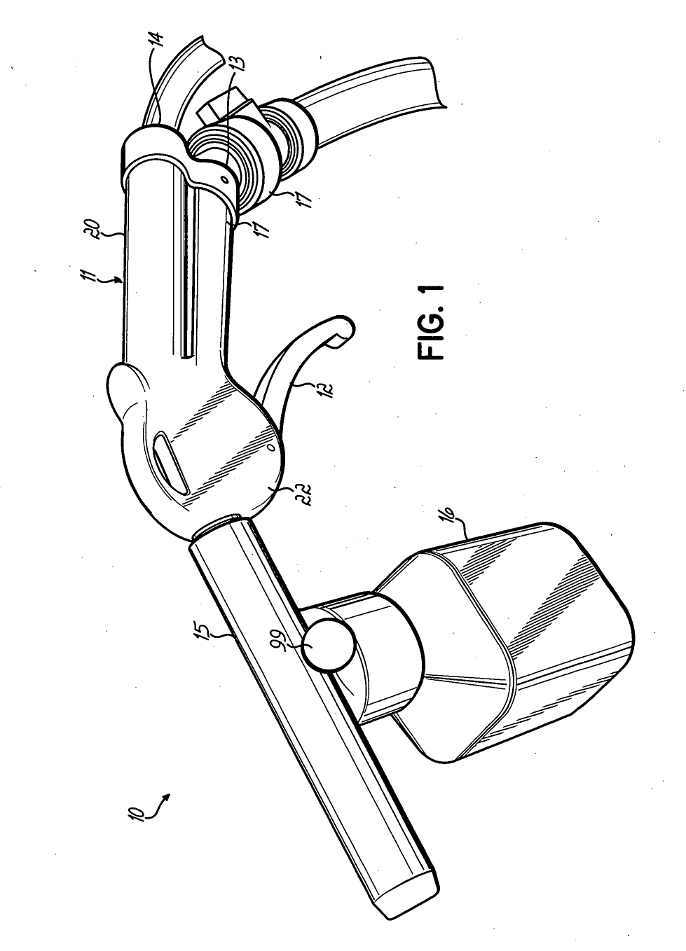

As shown in FIG. 1, the present invention is a spray gun, or spray washer 10, that includes a handle 11 and an actuating lever or trigger 12.

The handle 11 includes a water inlet 13 and an air inlet 14. Attached to the handle 11 is a discharge nozzle 15 that has a detergent reservoir 16 attached thereto.

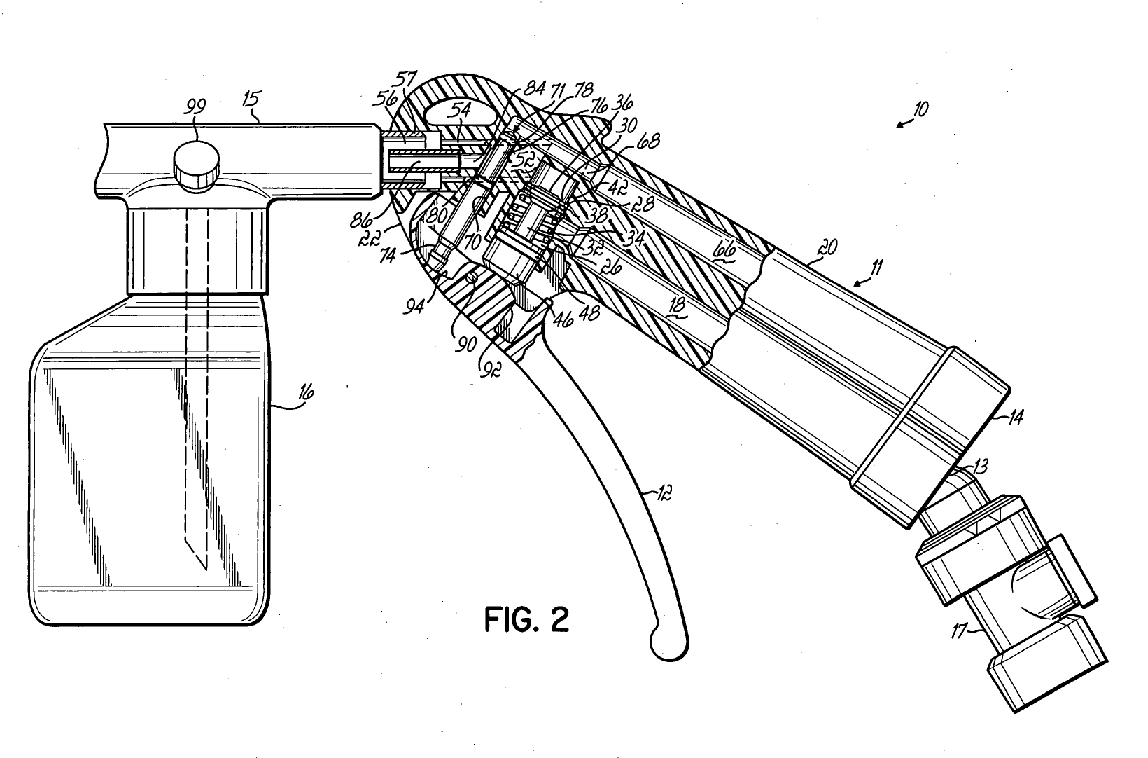

As shown more particularly in FIG. 2, the water inlet 13 has a separate valve 17 attached downstream of handle 11. Upstream of the water inlet 13 is a water passage 18 that extends through the handle stem 20 leading to the body portion 22 of handle 11. The water passage 18 leads to a water valve assembly 24 located in the body portion 22 of handle 11.

The valve assembly 24 is located in a cylindrical cavity 26 which communicates with water passage 18 and leads to two crescent-shaped passages 52a and 52b. Cavity 26 includes a small shoulder 28. Valve ring 30 is seated on shoulder 28. A plunger 32 is biased by spring 34 against the valve ring 30. The plunger includes a head portion or stopper 36 which includes an O-ring 38 which seats in the valve ring 30, preventing water flow from passage 18 to exit passages 52a and 52b. Plunger 32 further includes a lower enlarged portion 46 that has an O-ring 48 that seals a bottom portion of cavity 26. The enlarged portion 46 has a shoulder 50, and spring 34 rests on shoulder 50 biased between the valve ring 30 and shoulder 50.

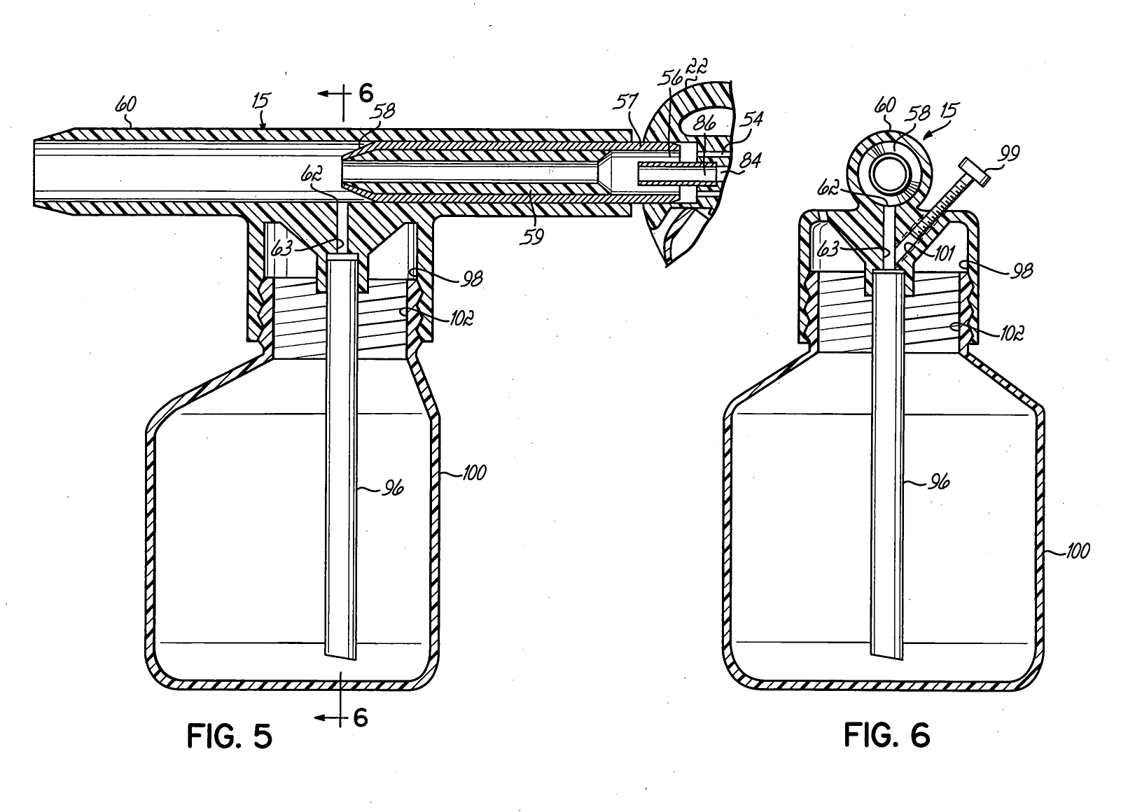

The crescent-shaped passages 52a and 52b lead to an annular passage 54. Annular passage 54, in turn, leads to a outlet 56 connected to a metal tubular insert 57 that is friction-fitted within the handle 11 aligned with the annular passage 54. As shown in FIG. 5, the metal insert 57 has a tip portion 58 that passes into tubular outlet nozzle 60 and terminates adjacent to a detergent inlet orifice 62, as is discussed below. A tubular insert 59 restricts the exit portion of insert 57.

The air inlet 14, which is typically attached to an air hose (not shown), leads to an air passage 66 through the stem portion 20 of handle 11. This leads to an air passage 68 which is simply a tube that leads to the air valve assembly 71. The air valve assembly 71 rests in a cylindrical cavity 70. Cavity 70 extends up to air passage 68. Within the cavity 70 is a post 72 which includes a lower portion 74 and an upper narrow portion 76. Upper narrow portion 76 includes upper and lower O-rings 78 and 80. These O-rings seal between the upper portion 76 and the walls of cavity 70. The cavity 70, in turn, leads to an air outlet passage 84. Air outlet passage 84, in turn, leads to an outlet tube 86. Outlet tube 86 is a metal insert that is compression fitted into handle 11, and surrounded by outlet 56. Tube 86 also terminates within insert 57 upstream of tubular insert 59.

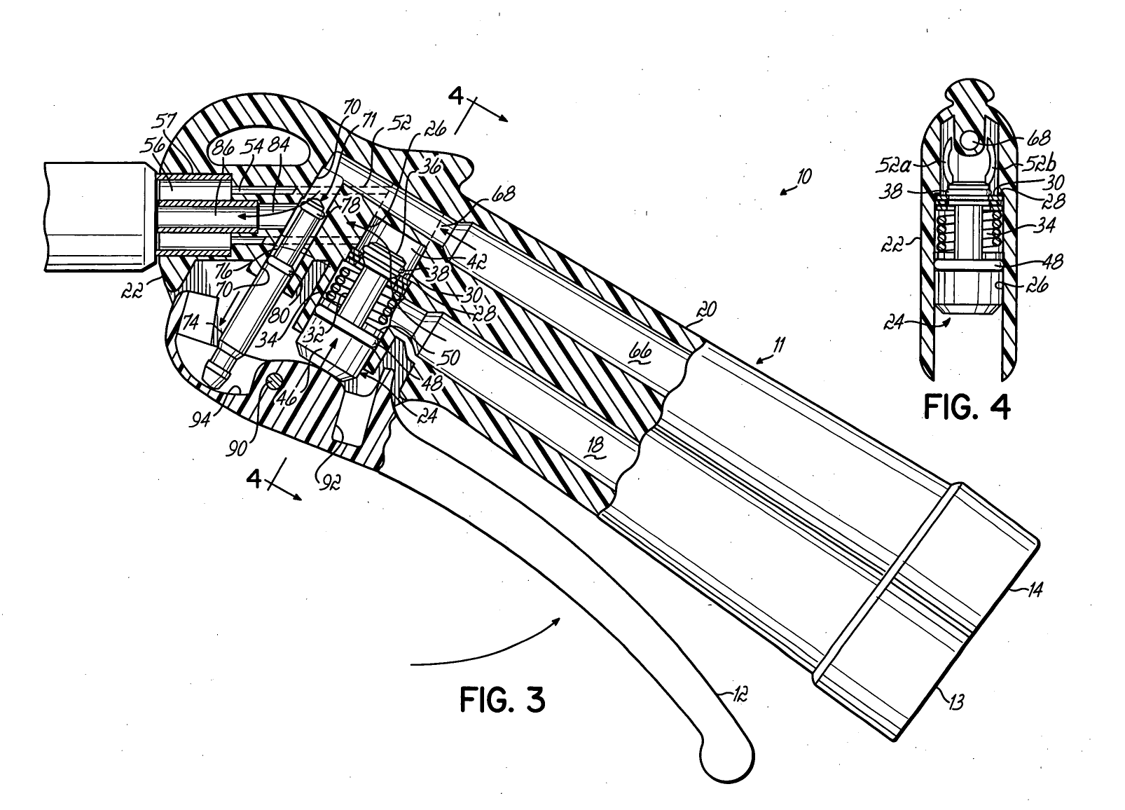

As is shown in FIG. 3, crescent-shaped water passages 52a and 52b, which run from area 42 to annular passage 56, are located on either side of cavity 70.

The handle 11 further includes the trigger portion 12, which is attached to the body 22 of handle 11 by a pivot pin 90. Trigger 12 further includes an enlarged portion 92 that is on one side of pivot pin 90, and a recessed portion 94 on the opposite side of pivot pin 90. As the trigger 12 is moved, the raised portion 92 moves in one direction, whereas the recessed portion 94 moves in the opposite direction.

The outlet nozzle 60, encircles outlet tubes 56 and 86. Detergent orifice 62 leads from nozzle 60 through an internally threaded cap 98 to tube 96. A container 100 with an externally threaded neck 102 attaches to the internally threaded cap 98 of the discharge nozzle 60. When the container 100 is attached to cap 98, tube 96 extends into container 100. The cap 98 includes an externally threaded stop screw 99 that is held in a threaded passage 101 leading to the opening 62. Rotation of this screw 99 opens and closes passage 63 between opening 62 and tube 96.

In operation, the container is filled with the desired liquid, either cleaner or degreaser. If one wants to spray only air, the valve 17 is closed and the screw 99 is rotated so that it blocks passage 63 to opening 62. The trigger 12 is squeezed, which causes the trigger 12 to rotate about pin 90. Recessed portion 94 moves away from the body portion 22 allowing the valve member 72 to move downwardly in the same direction. This will bring the upper O-ring 78 into an enlarged portion of cavity 70, which will allow air flow from tube 68 to exit port 84 and through tube 86 out the nozzle 60.

If water is desired, the valve 17 is opened so that water is directed to valve assembly 24. The same movement of the trigger which opened air valve assembly 71 will also press plunger 32 upwardly, causing the O-ring 38 to unseat from the valve ring 30, which will allow water to pass through passage 18 and cavity 26 into passageway 52 through annular opening 54 and out the outlet 56. In this embodiment, both air and water will be sprayed at the same time.

If detergent is required at the same time, this same action will be repeated, but the screw 99 will be rotated to open passage 63 to orifice 62 thereby allowing detergent to be drawn through tube 96. This will intermix with the air and water, and a combination of detergent, air and water will be sprayed from the nozzle 60.

This allows one to change from air, to air and water, to air, water and detergent very quickly while at the same time the actual mechanism itself is very simple.

This has been a description of the present invention along with the preferred method of practicing the present invention. However, the invention itself should only be defined by the appended claims,

Wherein we claim:

1. A spray washer comprising a compressed air inlet and a water inlet;
said compressed air inlet leading to a first valve, said water inlet leading to a second valve;
an actuator adapted to open said first and second valves simultaneously;
a conduit from said first valve to an air nozzle;
a conduit from said second valve to a water nozzle wherein said air nozzle and said water nozzle are coaxially positioned relative to each other and located within an outlet nozzle;
a venturi inlet downstream of said water nozzle and said air nozzle in communication with a reservoir;
a third valve between said reservoir and said venturi inlet;
a fourth valve effective to interrupt water flow into said water inlet.

2. The apparatus claimed in claim 1 wherein said actuator is a lever arm mechanism wherein said movement of said lever arm actuates said first and second valves simultaneously.

3. The apparatus claimed in claim 2 wherein said actuator is pivotally attached to said apparatus at a pivot point and wherein said first valve is contacted on a first side of said pivot point and said second valve is contacted by said lever by a second side of said pivot point.

4. The apparatus claimed in claim 3 wherein said third valve comprises a threaded member which, upon rotation, blocks a passage from said reservoir to said venturi nozzle.
